(19) United States
(12) Patent Application Publication
(10) Pub. No.: US 2024/0387083 A1
(43) Pub. Date: Nov. 21, 2024

(54) FE-BASED SOFT MAGNETIC ALLOY AND PREPARATION METHOD THEREFOR

(71) Applicant: AMOGREENTECH CO., LTD., Gimpo-si (KR)

(72) Inventors: Se Joong YOON, Gimpo-si (KR); Han Ho OH, Gimpo-si (KR)

(73) Assignee: AMOGREENTECH CO., LTD., Gimpo-si (KR)

(21) Appl. No.: 18/692,884

(22) PCT Filed: Sep. 19, 2022
(86) PCT No.: PCT/KR2022/013951

§ 371 Date: Mar. 18, 2024

(30) Foreign Application Priority Data
Sep. 17, 2021 (KR) 10-2021-0124559

(51) Int. Cl. H01F 1/147

(52) U.S. Cl. CPC H01F 1/14766

(57) ABSTRACT

Provided is an Fe-based soft magnetic alloy. An Fe-based soft magnetic alloy is represented by the empirical formula XₐB_{b}Si_{c}Cu_{d}Mₑ, wherein: X includes Fe and at least one element among Ni and Co; M includes at least one element among Nb and Mo; a, b, c, d, and e indicate the atomic percents (at %) of corresponding elements, in which 15.0≤b+c≤19.0, 0.5≤d≤1.5, and 2.0≤e≤5.0; and X is included as the remainder. Accordingly, the Fe-based soft magnetic alloy has high saturation magnetic flux density and low magnetic loss characteristics, and thus can be very easily used in various parts using magnetic materials. In addition, since the effect of heat treatment conditions can be minimized during the realization of uniform and small crystal grains after heat treatment, process conditions can be easily designed, so that the Fe-based soft magnetic alloy is very suitable for mass production.

### TECHNICAL FIELD

The present invention relates to an Fe-based soft magnetic alloy and a preparation method therefor.

### BACKGROUND

Soft magnetic materials are materials for the magnetic cores of various transformers, choke coils, various sensors, saturable reactors, magnetic switches and the like, and are used for supplying or converting power such as distribution transformers, laser power sources or accelerators, or are widely used as shielding materials against electromagnetic waves and magnetic fields in various electric and electronic devices. The market demands for such soft magnetic materials in the electric and electronic fields are focused on smaller size, lighter weight, higher performance/higher efficiency and lower unit prices, and in order to satisfy these market demands, research on soft magnetic materials with high saturation magnetic flux density and low magnetic loss is being actively conducted.

Accordingly, the soft magnetic materials of various compositions with excellent saturation magnetic flux density and magnetic loss have been introduced, but processing conditions are strict in the heat treatment process after preparing the initial alloy to express the desired level of characteristics, and thus, it is difficult to form a uniform nano-microstructure in heat-treated alloys, and as a result, the productivity of good products is poor such that there is a problem in that the mass production is difficult.

Meanwhile, as a method for preparing an Fe-based soft magnetic alloy, the rapid cooling solidification method in which molten metal is sprayed onto a roll rotating at high speed and rapidly cooled and solidified on the roll to obtain a thin ribbon is widely used. Through this method, a ribbon with a thickness of several μm can be obtained, and if the width of a ribbon is narrow, it is highly likely that a good product will be produced, such as controlling the initial alloy to be amorphous or forming a uniform nano-microstructure after heat treatment. However, as the width of a ribbon increases, it may not be easy to produce a good product, and even when a good product ribbon having a wide width is manufactured, it is difficult to ensure reproducibility for mass production.

Accordingly, there is an urgent need to develop an Fe-based soft magnetic material that is suitable for mass production, which has excellent characteristics such as saturation magnetic flux density and magnetic loss, and bas improved thermal stability, thereby making it easy to implement a uniform microstructure on the nanoscale.

### SUMMARY

### Technical Problem

The present invention has been devised in view of the above points, and has an object to provide an Fe-based soft magnetic alloy whose composition is designed such that it has a saturation magnetic flux density above a certain level, in which magnetic loss is minimized, and it has greater permeability characteristics, and even when undergoing a flake process, it prevents excessive fine fragmentation to be fragmented to an appropriate size so as to have a much larger permeability and low permeability loss rate, and a preparation method thereof.

In addition, the present invention has another object to provide an Fe-based soft magnetic alloy which is capable of mass production, in which in terms of preparing an amorphous initial alloy and implementing a uniform microstructure through heat treatment, the composition and range of heat treatment conditions are improved to increase the reproducibility of the implementation of an amorphous initial alloy, and it easily realizes the desired microstructure and physical properties through heat treatment, and a preparation method thereof.

In addition, the present invention has still another object to provide an Fe-based soft magnetic alloy which guarantees reproducibility in order to implement an amorphous initial alloy, even when it is implemented as a ribbon sheet with increased width, and a preparation method thereof.

### Technical Solution

In order to solve the above-described problems, the present invention provides an Fe-based soft magnetic alloy which is represented by the empirical formula XₐB_{b}Si_{c}Cu_{d}Mₑ, wherein in the empirical formula, X includes Fe and at least one element among Ni and Co; M includes at least one element among Nb and Mo; a, b, c, d and e indicate the atomic percent (at %) of corresponding elements, in which 15.0≤b+c≤19.0, 0.5≤d≤1.5, and 2.0≤e≤5.0; and X is included as the remainder.

According to an exemplary embodiment of the present invention, X includes at least one element among Ni and Co, and a may be included at 75.0 to 81.5 at %, Co may be included at 2.0 to 5.0 at %, and Ni may be included at 0 to 1 at % in the empirical formula.

In addition, b may be 11.0 to 16.0 at %, and c may be 2.0 to 6.5 at % in the empirical formula.

Additionally, in the empirical formula, b may be 11.0 to 16.0 at %, and the value according to Mathematical Formula 1 below for a, b and c may be 2.75 to 4.70, more preferably, 3.20 to 4.50, and even more preferably, 3.40 to 4.20:

$$\frac{{( b + c )}^{2}}{a}$$

In addition, c may be 2.0 to 5.0 at % in the empirical formula.

In addition, M may include Nb and Mo in the empirical formula. In this case, Nb may be contained in a greater content than Mo.

In addition, e may be 2.5 to 4.0 at % in the empirical formula.

In addition, the soft magnetic alloy may include crystal grains that have an amorphous structure or an average particle diameter of 40 nm or less in an amorphous matrix., and more preferably, the average particle diameter of crystal grains may be 30 nm or less.

In addition, the crystal grains may be included in an amount of 40% by volume or more of the amorphous matrix.

In addition, the saturation magnetic flux density may be 1.4 T or more, and more preferably, 1.6 T or more.

In addition, the present invention provides a method for preparing an Fe-based soft magnetic alloy, including the step of preparing a soft magnetic alloy which is represented by the empirical formula XₐB_{b}Si_{c}Cu_{d}Mₑ, wherein in the empirical formula, X includes Fe and at least one element among Ni and Co; M includes at least one element among Nb and Mo; a, b, c, d and e indicate the atomic percent (at %) of corresponding elements, in which 15.0≤b+c≤19.0, 0.55d≤1.5, and 2.0≤e≤5.0; and X is included as the remainder.

According to an exemplary embodiment of the present invention, the method may further include the step of heat treating the soft magnetic alloy at a temperature of 530 to 620° C. for 10 to 60 minutes.

In addition, the present invention provides a shielding member, including the Fe-based soft magnetic alloy according to the present invention.

Hereinafter, terms used in the present invention will be described.

As a term used in the present invention, “initial alloy” refers to an alloy in a state that has not undergone a separate treatment, for example, a process such as heat treatment, in order to change the characteristics of the prepared alloy.

### Advantageous Effects

According to the present invention, the Fe-based soft magnetic alloy can have a saturation magnetic flux density above a certain level, in which magnetic loss is minimized, and it bas greater permeability characteristics, and even when undergoing a flake process, it prevents excessive fine fragmentation to be fragmented to an appropriate size so as to have excellent magnetic properties such as a much larger permeability and low permeability loss rate. Additionally, in terms of preparing an amorphous initial alloy and implementing a uniform microstructure through heat treatment, the composition and range of heat treatment conditions can be improved to increase the reproducibility of the implementation of an amorphous initial alloy, and it easily realizes the desired microstructure and physical properties through heat treatment, and mass production is possible. Furthermore, even when it is implemented as a ribbon sheet with increased width, it guarantees reproducibility in order to implement an amorphous initial alloy, and therefore, after heat treatment, wide, good quality Fe-based soft magnetic alloy ribbon sheets can be mass-produced. Accordingly, the Fe-based soft magnetic alloy according to an exemplary embodiment of the present invention can be widely applied as a magnetic component of electric and electronic devices such as a high-power laser, a high-frequency power supply, a high-speed pulse generator, an SMPS, a high-frequency filter, a low-loss high-frequency transformer, a high-speed switch, wireless power transmission, electromagnetic wave shielding and the like.

### BRIEF DESCRIPTION OF THE DRAWINGS

FIGS. 1 and 2 are TEM images of the Fe-based soft magnetic alloy according to an exemplary embodiment of the present invention.

FIGS. 3 and 4 are VSM graphs of the Fe-based soft magnetic alloy according to an exemplary embodiment of the present invention.

FIG. 5 is a photograph of the apparatus for measuring the permeability of an Fe-based soft magnetic alloy according to an exemplary embodiment of the present invention.

### DETAILED DESCRIPTION OF THE EMBODIMENTS

Hereinafter, the exemplary embodiments of the present invention will be described in detail so that those skilled in the art can easily practice the present invention. The present invention may be embodied in many different forms and is not limited to the exemplary embodiments set forth herein.

The Fe-based soft magnetic alloy according to the present invention is represented by the empirical formula XₐB_{b}Si_{c}Cu_{d}Mₑ, wherein in the empirical formula, X includes Fe and at least one element among Ni and Co; M includes at least one element among Nb and Mo; a, b, c, d and e indicate the atomic percent (at %) of corresponding elements, in which 15.0≤b+c≤19.0, 0.5≤d≤1.5, and 2.0≤e≤5.0; and X is included as the remainder.

The X is a main element of the alloy that expresses the magnetism of the soft magnetic alloy, and includes Fe, and also includes at least one among Co and Ni in addition to Fe, and preferably, it may include Fe and Co. Meanwhile, in the case of Ni, it is preferable not to include the same, and even when it is included, it is preferable to include the same in a content within 1 at % in the soft magnetic alloy. If Ni is included, there is a concern that magnetic loss such as core loss may increase when it is included in an alloy exceeding 1 at %. Including Fe alone as X may be advantageous in improving the saturation magnetic flux density, but it is not easy to implement an amorphous initial alloy, and it may be difficult to prepare a soft magnetic alloy having a uniform microstructure as the range of heat treatment temperature selection narrows. In addition, reproducibility is lowered, which may be disadvantageous for mass production. However, in the case of having both Fe and Co, it may be advantageous to minimize magnetic properties, particularly magnetic loss, and implement high permeability of the alloy to be prepared. In addition, corrosion resistance may be additionally improved. In addition, it may have high permeability in a frequency band of 1 kHz or more to 100 MHz or less, and has the advantage of reducing mechanical vibration, noise or eddy current therefrom due to reduced magnetostriction. In addition, it may be combined with elements B, Si, Cu and M described below to increase the reproducibility of implementing an amorphous initial alloy, and it is easy to design process conditions such as temperature conditions during heat treatment. As such, there is an advantage in mass-producing a soft magnetic alloy having a high saturation magnetic flux density at a certain level or above, low magnetic loss and high permeability.

The X may be included in a content of 75.0 to 81.5 at %, more preferably, 75.0 to 81.0 at %, even more preferably 75 to 80 at %, and even more preferably 76 to 80 at % in the soft magnetic alloy, and through this, it may be advantageous to implement a high saturation magnetic flux density of 1.4 T or more, and more preferably, 1.6 T or more. If X is more than 81.5 at %, the content of the remaining elements is inevitably reduced, and as a result, it is difficult to easily implement an amorphous initial alloy or the reproducibility of implementing an amorphous initial alloy may be reduced. In addition, if X is contained at less than 75 at %, it may be difficult to implement sufficient saturation magnetic flux density, and it may be difficult to implement the reproducibility of an amorphous initial alloy or a wide ribbon sheet of good quality.

In addition, when at least one of Ni and Co is provided together with Fe as X, the sum of the contents of Ni and Co in the soft magnetic alloy may be 2.0 to 5.0 at %, wherein the content of Ni may be included in a content of more than 0 at % and within 1 at %. In addition, when Ni is not included and Fe and Co are included, Co may be included in a content of 2.0 to 5.0 at %, and more preferably, 3.0 to 5.0 at %, and through this, a high saturation magnetic flux density is achieved while it is easy to implement an amorphous initial alloy, and it is advantageous to achieve magnetic loss such as low core loss. In addition, since thermal characteristics are improved, process design during heat treatment may be facilitated. If Co is contained at less than 2.0 at %, the above-mentioned effects may not be achieved or may be insignificant, and if it is more than 5.0 at %, there is a risk of cost increase, and the content of Fe is relatively reduced such that it is difficult to realize sufficient saturation magnetic flux density, and the coercive force may increase. Meanwhile, the content of Fe may be contained at 78 a % or less, 77 at % or less, 76 a % or less, and for example, 72 to 76 at % or 73 to 75 at %. If Fe is more than 78 at %, the magnetostriction of the alloy increases, which may increase vibration and noise therefrom, degrade high-frequency characteristics, cause heat generation due to eddy currents, and make it difficult to design heat treatment processes.

Next, elements B and Si in the above empirical formula are elements having an amorphous forming ability, through which an initial alloy can be easily prepared in an amorphous phase. In addition, Si may further improve magnetic properties such as the reduction of magnetostriction and the improvement of permeability of the soft magnetic alloy. The value of b+c, which is the sum of the contents of each of the elements B and Si in the empirical formula, may be 15.0 to 19.0 at %, preferably, 15.0 to 18.0 at %, and more preferably, 16.0 to 18.0 at %. If the value of b+c is more than 19.0 at %, the content of X is relatively reduced, and as a result, it may be difficult to have sufficient magnetic properties, particularly, a saturation magnetic flux density of 1.4 T or more, and magnetic loss may increase. In addition, the content of Co contained in X may decrease, and in this case, heat treatment process design may be difficult. In addition, as will be described below, there is a concern that the content of silicon may increase, and as a result, the reproducibility of implementing an amorphous initial alloy may be lowered or it may be difficult to implement a wide ribbon sheet. In addition, if the value of b+c is less than 15 at %, it is difficult to implement an amorphous initial alloy, or even if it is implemented, reproducibility is lowered, thereby making mass production difficult.

According to an exemplary embodiment of the present invention, for the contents b and c in the empirical formula of B and Si, in relation to a which is the content of X, when b is 11.0 to 16.0 at %, the value of Mathematical Formula 1 below may be 2.75 to 4.50, more preferably, 3.20 to 4.50, even more preferably, 3.40 to 4.50, and even more preferably, 3.40 to 4.20, and through this, it may be more advantageous to achieve the objects of the present invention.

$$\frac{{( b + c )}^{2}}{a} \qquad [ Mathematical Formula 1 ]$$

If the value of Mathematical Formula 1 is less than 2.75, it is difficult to implement an amorphous initial alloy, or even if it is implemented, reproducibility is lowered, thereby making mass production difficult. In addition, if the value of Equation 1 is more than 4.50, it may be difficult to have a high saturation magnetic flux density, and it may be difficult to increase magnetic loss or to express high permeability in a frequency band of 10 kHz or more. In addition, it may be difficult to design a heat treatment process, and through this, it may be difficult to implement an Fe-based soft magnetic alloy having uniform quality after heat treatment. In addition, it may be difficult to implement a wide ribbon sheet. In addition, even when the preferred value of Mathematical Formula 1 is satisfied, if the value of b is less than 11.0 at %, it may not be easy to implement an amorphous initial alloy.

In addition, element B in the empirical formula may be provided in an amount of 9.0 to 16.0 at %, more preferably, 11.0 to 16.0 at %, and even more preferably, 12.0 to 15.0 at % in the soft magnetic alloy. If the content of element B is less than 9.0, it may not be easy to implement an amorphous initial alloy even when the content of Si, which will be described below, is increased, and crystals in the initial alloy make the uniform growth of crystals generated during heat treatment to change magnetic properties difficult, and crystals with coarse grain sizes may be included, and as a result, it may increase magnetic loss. In addition, if the content of B is more than 16.0 at %, the content of other elements in the alloy is relatively reduced, and thus, after heat treatment, it may be difficult to grow crystal grains to have a uniform grain size or it may be difficult to exhibit a desired level of magnetic properties.

Next, in the above empirical formula, the element Si may be included in the soft magnetic alloy at 2.0 to 6.5 at %, more preferably, 2.0 to 6.0 at %, even more preferably, 2.5 to 6.0 at %, and even more preferably, 3.0 to 5.0 at %. If the element Si is provided in a content of less than 2.0 at %, it may not be easy to achieve the objects of the invention, such as insignificant improvement in magnetic properties. In addition, if the element Si is provided in excess of 6.5 at %, it may be difficult to prepare the initial alloy in an amorphous phase, or the reproducibility of the amorphous initial alloy may be lowered, and the content of other elements provided in the alloy is relatively reduced, and thus, after heat treatment, it may be difficult to grow crystal grains to have a uniform grain size or it may be difficult to exhibit a desired level of magnetic properties.

Next, in the above empirical formula, element Cu is an element that plays a role as a nucleation site which is capable of generating crystals in the initial alloy, and it easily implements the amorphous initial alloy as a nanocrystalline grain alloy. The Cu element allows the crystalline phase of the initial alloy to be amorphous such that the crystals generated after heat treatment become nanocrystalline grains, and for the remarkable expression of desired physical properties, the Cu element may be included in the alloy at 0.5 to 1.5 at %, and preferably, at 0.7 to 1.1 at %. If the element Cu is included at less than 0.5 at % in the alloy, the specific resistance of the soft magnetic alloy produced is greatly reduced, and magnetic loss due to eddy current may increase, and nanocrystalline grains are not generated at a desired level in the heat-treated alloy, and when crystals are generated, it may not be easy to control the grain size of the generated crystals. In addition, if the element Cu is included at more than 1.5 at % in the alloy, the formation of a crystalline initial alloy increases, and the crystals that are already formed in the initial alloy make the grain size of the crystals generated during heat treatment non-uniform, and crystals that are grown to a size greater than the desired level may be included in the alloy, and as a result, the magnetic characteristics may not be achieved at the desired level, such as increasing magnetic loss. In addition, the content of other elements in the alloy is relatively reduced, and thus, after heat treatment, it may be difficult to grow crystal grains to have a uniform grain size or it may be difficult to exhibit a desired level of magnetic properties.

Next, element M in the above empirical formula facilitates the realization of the amorphous phase in the initial alloy, increases the reproducibility of the amorphous initial alloy, and improves the uniformity of the grain size in the alloy after heat treatment, and at the same time, it is an element that improves soft magnetic properties by reducing magnetostriction and magnetic anisotropy and can contribute to improving magnetic properties in response to temperature changes, and it may include at least one of Nb and Mo, and preferably, it may include both of Nb and Mo. The element M is included at 2.0 to 5.0 at %, and more preferably, 2.5 to 4.0 at % in the soft magnetic alloy, and if the element M is included at less than 2.0 at %, the reduction in nanocrystal grain size or improvement in uniformity is minimal during heat treatment, thereby making it difficult to improve magnetic properties such as core loss and permeability. In addition, if the element M is more than 5.0 at %, the control of the nanocrystal grain size may be somewhat advantageous, but the saturation magnetic flux density may decrease or it may not be easy to implement amorphousness in the initial alloy. In addition, when the element M includes both of Nb and Mo, Nb in the soft magnetic alloy may be included in a larger content than Mo, and through this, it may be more advantageous in achieving the desired effects of the present invention. Meanwhile, Nb may be included at 1.5 to 3.0 at %, and Mo may be included at 0.5 to 2.0 at %, and more preferably, 1.0 to 1.5 at %, and through this, it may be advantageous in achieving the desired effects without increasing material costs.

Meanwhile, the soft magnetic alloy according to the present invention does not include element C, and this may reduce the implementation reproducibility of the amorphous initial alloy, but it may be overcome through the combination and content control of the other alloy elements including Co, which can be provided as the X element, and by not including the element C, the magnetic properties may be more advantageously improved. In addition, the soft magnetic alloy according to the present invention does not include the element P as an element constituting the alloy, and the P element also makes it difficult to control the grain size through the amorphization of the initial alloy and the heat treatment of the initial alloy, and as it exhibits low permeability characteristics in the high frequency region, there is a problem in that it is difficult to achieve high permeability.

The above-described Fe-based soft magnetic alloy may further include unavoidable impurities that may be included in conventional soft magnetic alloys in addition to elements of the empirical formula. The impurities may be elements that are commonly known to be contained in soft magnetic alloys, such as C, N, S and O). The content of the impurities may be acceptable within a range that does not affect the achievement of desired magnetic properties and the preparation process, and may be, for example, less than 1% by weight, and more preferably, less than 0.5% by weight in the alloy.

In addition, the soft magnetic alloy may have an amorphous structure in the case of an initial alloy, and may include crystal grains that have an average particle diameter of 40 nm or less, more preferably, 30 nm or less, and even more preferably, 10 to 25 nm in the amorphous matrix after heat treatment. In addition, the generated crystal grains may include coarse crystal grains exceeding 2.5 times the average grain diameter in an amount of 10% or less, more preferably, 5% or less, and even more preferably, not including any, among the number of crystal grains in the measurement area.

In addition, crystal grains may be included in an amount of 40% by volume or more, and for example, 95% by volume or less in the amorphous matrix. In addition, the produced crystal may be implemented to have a uniform particle size such that it has an excellent nano-microstructure and thus excellent magnetic properties.

The Fe-based soft magnetic alloy implemented as an example may have a saturation magnetic flux density of 1.4 T or more, more preferably, 1.5 T or more, and even more preferably, 1.6 T or more, and while each surface roughness (Ra) of both surfaces of the prepared Fe-based soft magnetic alloy ribbon sheet is 0.72 μm or less, the surface roughness difference of both surfaces may be 0.065 μm or less, and through this, it may be advantageous to implement an amorphous initial alloy, and the magnetic properties are excellent, such as minimizing the magnetic loss of a magnetic article manufactured by stacking ribbon sheets in multiple layers.

In addition, the Fe-based alloy according to an exemplary embodiment of the present invention may have a core loss (Pcv) measured at 0.1 T of 170 mW/cm³ or less at 50 kHz, more preferably, 130 mW/cm³ or less, and even more preferably, 100 mW/cm³ or less, and still more preferably, 70 mW/cm³ or less, and at 100 kHz, it may be 300 mW/cm³ or less, and more preferably, 200 mW/cm³ or less. In addition, after stacking 4 ribbon sheets with a width of 20 mm and a thickness of 18 μm, the permeability measured after being inserted into a bobbin having an outer diameter of 25 cm and an inner diameter of 20 cm and winding in a toroidal form may be 5,000 or more at 100 kHz, more preferably, 6,000 or more, and even more preferably, 6,500 or more, and it may be useful as a shielding member for electromagnetic waves or magnetic fields due to high permeability while having a high saturation magnetic flux density at a certain level or more.

In the Fe-based soft magnetic alloy having the composition according to the present invention as described above, the crystalline phase may be substantially amorphous in the initial alloy, and through this, it is advantageous to uniformly form the grain size of the generated crystal grains while preventing the generation of coarse crystal grains after heat treatment. Herein, the substantially amorphous phase does not mean only a completely amorphous crystalline phase, and means that a completely amorphous phase or ultrafine crystals having a particle diameter of less than 1 nm, which is difficult to measure with the current technology level, may be partially included.

In addition, the Fe-based soft magnetic alloy having the composition according to the present invention easily implements uniform and small crystal grains, and it minimizes or does not include coarse crystal grains, and thus, in order to reduce magnetic loss due to eddy current, the shielding member which is implemented by including the alloy ribbon sheet is processed into flakes, and when the ribbon sheet within the shielding member is implemented in a fragmented state, it prevents excessive fine fragmentation, and through this, it is advantageous to prevent magnetic properties such as permeability from deteriorating.

The soft magnetic alloy having the composition according to the present invention as described above may be prepared by the preparation method described below, but the present invention is not limited thereto.

The soft magnetic alloy included in an exemplary embodiment of the present invention may be prepared by melting and rapidly solidifying an alloy-forming composition or master alloy in which base materials including each element are weighed and mixed so as to satisfy the above-described empirical formula of the soft magnetic alloy. The shape of the prepared initial alloy may vary according to a specific method used during the rapid solidification. Since the method used for the rapid solidification may employ a conventionally known method, the present invention is not particularly limited thereto. However, as a non-limiting example thereof, the rapid solidification may be performed through a known atomizing method, and specifically, there are the gas injection method in which a molten Fe-based master alloy or Fe-based alloy forming composition is prepared in powder form through high-pressure gas (e.g., Ar, N₂, He, etc.) and/or high-pressure water, the centrifugal separation method that produces a powder phase using a disk that rapidly rotates molten metal, the melt spinning method that produces a ribbon by using a roll that rotates at a high speed and the like. The shape of the soft magnetic initial alloy formed through these methods may be in the form of a powder, a ribbon or a magnetic core formed by winding the ribbon multiple times to have a predetermined inner diameter and a predetermined outer diameter.

Meanwhile, the shape of the initial alloy may be a bulk form. When the shape of the initial alloy is bulk, the amorphous alloy powder formed by the above-described methods may be prepared into a bulk amorphous alloy through commonly known methods, such as the coalescence method and the solidification method. As non-limiting examples of the coalescence method, methods such as shock consolidation, explosive forming, powder sintering, hot extrusion and hot rolling may be used. Among these, when the shock consolidation is explained, the shock consolidation applies a shock wave to a powder alloy polymer such that the wave is transmitted along the grain boundary and energy absorption occurs at the grain interface, and at this time, the absorbed energy forms a fine molten layer on the particle surface, thereby making it possible to produce a bulk amorphous alloy. In this case, the generated molten layer must be cooled sufficiently rapidly to maintain an amorphous state through heat transfer to the inside of the particle. Through this method, it is possible to prepare a bulk amorphous alloy having a packing density of up to 99% of the original density of the amorphous alloy, and it has the advantage of achieving sufficient mechanical properties. In addition, the hot extrusion and hot rolling uses the fluidity of an amorphous alloy at a high temperature, and a bulk amorphous alloy having sufficient density and strength may be prepared by heating and rolling an amorphous alloy powder to a temperature near Tg, and then rapidly cooling after rolling forming. Meanwhile, the solidification method may include copper mold casting, high pressure die casting, arc melting, unidirectional melting, squeeze casting, strip casting and the like, and since each method can employ known methods and conditions, the present invention is not particularly limited thereto.

In addition, the step of heat treatment may be further performed on the soft magnetic alloy in the initial alloy state which is implemented in an amorphous phase. The heat treatment is a step of transforming the atomic arrangement of the Fe-based initial alloy from amorphous to crystalline, and nanocrystalline grains may be generated through the heat treatment. However, since the size and shape of the formed crystals may vary depending on the heat treatment temperature, temperature increase rate and/or treatment time, the control of heat treatment conditions is very important in controlling the grain size and shape.

Specifically, the heat treatment may be performed for 10 minutes to 60 minutes at a heat treatment temperature of 530° C. to 620° C. as one example, and the heat treatment time, temperature, temperature increase rate and the like may be appropriately adjusted according to the composition of the soft magnetic alloy. When the heat treatment temperature is less than 530° C., no or small amounts of nanocrystal grains may be generated, and in this case, a soft magnetic alloy that does not exhibit the desired magnetic properties may be prepared. In addition, if the heat treatment temperature is more than 620° C., the grain size of the crystals generated in the alloy may be coarsened, and since the grain size distribution of the generated crystals becomes very wide, it reduces the uniformity of the grain size, and the crystals of X and other intermetallic compounds may be excessively generated rather than the desired crystal grains. In addition, since the heat treatment time may be relatively short due to the high heat treatment temperature, it may be more difficult to control the generated crystal grains. Furthermore, the implemented soft magnetic alloy may not have desired magnetic properties, such as a decrease in saturation magnetic flux density and an increase in magnetic loss such as coercive force and core loss.

In addition, according to an exemplary embodiment of the present invention, the temperature increase rate up to the heat treatment temperature may also affect the particle size control of the generated nanocrystal grains, and for example, the temperature increase rate from room temperature to the heat treatment temperature which is up to 100° C./minutes may be advantageous for preparing a soft magnetic alloy having desired magnetic properties. The soft magnetic alloy prepared by heat-treating the initial alloy through the above-described method may have an amorphous structure or may include crystal grains having an average grain size of 40 nm or less, preferably, 30 nm or less, and more preferably, 25 nm or less in the amorphous matrix. If the average grain diameter of the crystal grains is more than 40 nm, it may not be possible to satisfy all of the desired magnetic properties, such as an increase in coercive force.

In addition, the Fe-based soft magnetic alloy implemented by the above method may be a ribbon sheet. The ribbon sheet may have a width of 10 mm or more, and more preferably, 20 mm or more, and it may be, for example, 10 to 100 mm, and as another example, 10 to 80 mm, but the present invention is not limited thereto. The Fe-based soft magnetic alloy ribbon sheet according to an exemplary embodiment of the present invention, which is implemented in a wide width but has a uniform structure and high reproducibility of magnetic properties, is useful for implementing a large-area shielding member.

Accordingly, the present invention provides a shielding member including an Fe-based soft magnetic alloy, which is a ribbon sheet, according to an exemplary embodiment of the present invention. Additionally, in order to minimize magnetic loss such as eddy current, the ribbon sheet in the shielding member may be flaked and in a fragmented state. Meanwhile, the fragmented state is realized through flake processing after being implemented as a shielding member, and it is a form in which the ribbon sheet is split into a plurality of pieces while maintaining the appearance of the ribbon sheet, and it is noted that it is different in shape and physical properties from that in which a sheet is implemented by a soft magnetic alloy powder and provided in a shielding member.

### Modes of the Invention

The present invention will be described in more detail through the following examples, but the following examples are not intended to limit the scope of the present invention, which should be interpreted to aid understanding of the present invention.

### Example 1

After weighing raw materials of Fe, Co, B, Si, Nb, Cu and Mo to prepare an Fe-based master alloy represented by the empirical formula Fe_{74.5}Co_{4.5}B_{13.0}Si_{4.0}Cu_{1.0}Nb_{2.0}Mo_{1.0}, the Fe-based master alloy was prepared by using the arc melting method. Thereafter, the prepared Fe-based master alloy was melted and rapidly cooled at a rate of 10⁶ K/sec through melt spinning at a rate of 60 m/s in an Ar atmosphere to prepare a ribbon-shaped Fe-based soft magnetic initial alloy with a thickness of approximately 18 μm and a width of 20 mm.

Afterwards, the prepared ribbon-shaped Fe-based soft magnetic initial alloy was wound to have an outer diameter of 20 mm and an inner diameter of 10 mm, and 4 pieces of the magnetic core-shaped initial alloy or ribbon-shaped Fe-based soft magnetic initial alloys were laminated, and then heat treated at room temperature at a temperature increase rate of 80° C./min to maintain at 540° C. for 20 minutes, thereby preparing an Fe-based soft magnetic alloy as shown in Table 1 below.

### Example 2

It was prepared in the same manner as in Example 1, except that it was changed to prepare an Fe-based master alloy represented by Fe_{74.5}Co_{4.0}B_{13.0}Si_{4.5}Cu_{1.0}Nb_{2.0}Mo_{1.0} to prepare an Fe-based soft magnetic alloy as shown in Table 1 below.

### Experimental Example 1

The following physical properties were measured for the Fe-based soft magnetic alloys according to Examples 1 and 2, and the results are shown in Table 1 below.

### 1. Analysis of Crystal Structure

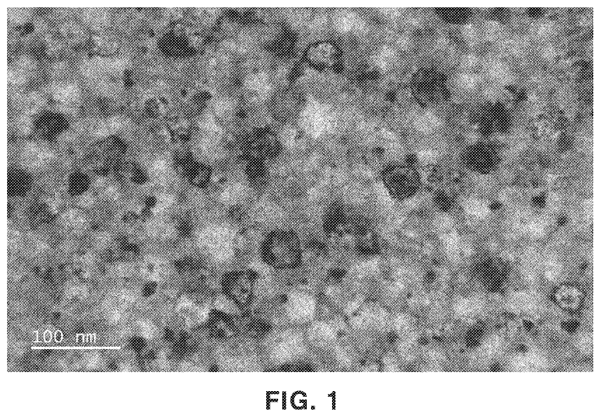

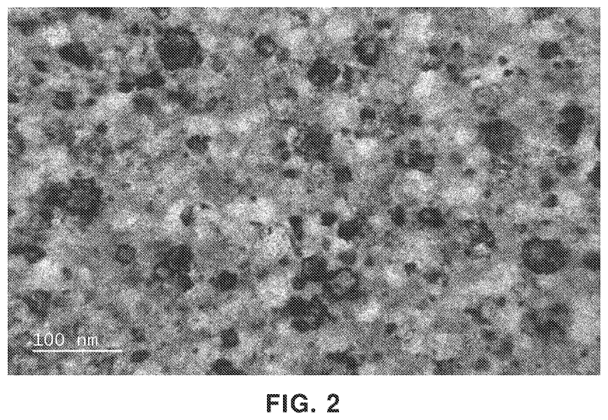

XRD patterns and TEM were analyzed to confirm the crystalline phase of the prepared initial alloy and the alloy after heat treatment and the average particle diameter of the generated crystals, and the TEM image (×50,000) of Example 1 after heat treatment is shown in FIG. 1, and the TEM image (×50,000) of Example 2 after heat treatment is shown in FIG. 2.

In addition, the volume percentage (vol %) of the crystals was calculated by Relationship Formula 1 below from the XRD patterns of Examples 1 and 2 after heat treatment.

$$[ Relationship Formula 1 ]$$

$$Volume \% = [ Area of crystalline region / ( Area of crystalline region + Area of amorphous region ) ] \times 100$$

In addition, the average particle diameter was calculated by measuring the particle diameter in the TEM image using a TEM-scale bar. In addition, the proportion of coarse particles exceeding 2.0 times the average particle diameter was calculated.

### 2. Evaluation of Magnetic Properties

A vibrating sample-type magnetometer (VSM) was used to calculate the coercive force and saturation magnetization value (Bs) or maximum magnetic flux density (Bm) of Sample 1, which is a magnetic core, and evaluated at 800 A/m and 1 kHz. In addition, Pcv was evaluated at 0.1 T, 50 KHz and 100 kHz by using a BH tracer measuring device (Iwatsu, SY-8219). In addition, the permeability was measured with an LCR meter after inserting a toroidal-shaped magnetic core into a plastic bobbin having the same size and winding 20 times with a copper wire coated with an insulating material, and in this case, the measurement conditions were conducted at a frequency of 100 kHz and 1V.

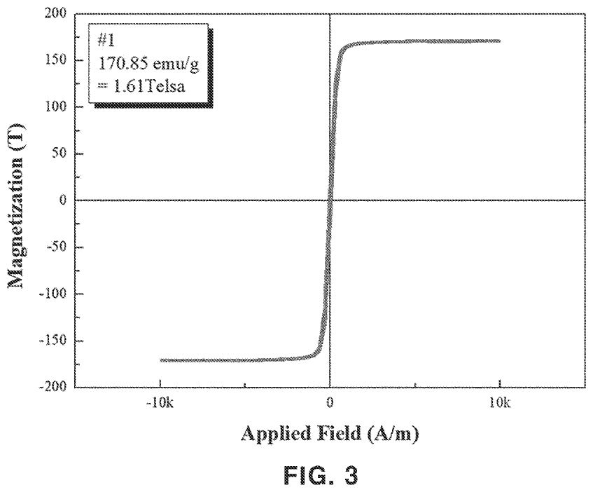

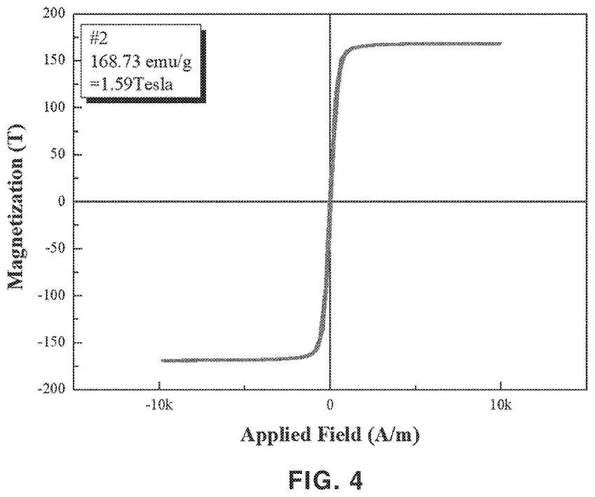

Among these, VSM graphs of the Fe-based soft magnetic alloys of Examples 1 and 2 are shown in FIGS. 3 and 4, respectively.

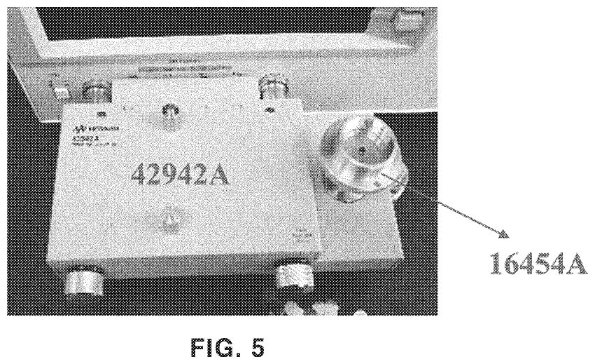

In addition, for Sample 2 derived from a ribbon sheet, the real number part of permeability at a frequency of 100 kHz was measured by using a dedicated fixture (KEYSIGHT 42942A, 16454A) as illustrated in FIG. 5.

In this case, the permeability was measured after inserting Sample 2 into a bobbin having an outer diameter of 25 cm and an inner diameter of 20 cm and winding in a toroidal shape.

TABLE 1

| | | | Example 1 | Example 2 |
|---|---|---|---|---|
| Composition | X | Fe | 74.5 | 74.5 |
| (at %) | | Co | 4.5 | 4.0 |
| | B | | 13.0 | 13.0 |
| | Si | | 4.0 | 4.5 |
| | Cu | | 1.0 | 1.0 |
| | Nb | | 2.0 | 2.0 |
| | Mo | | 1.0 | 1.0 |
| | Total | | 100 | 100 |
| | X | | 79.0 | 78.5 |
| | B + Si | | 17.0 | 17.5 |
| | Mathematical Formula 1 | | 3.66 | 3.90 |
| Initial Alloy | Width (mm) | | 20 | 20 |
| | Structure | | Amorphous | Amorphous |
| Fe-based | Heat treatment temperature | | 540° C., | 540° C., |
| Soft | (° C.)/Treatment time (min) | | 20 min | 20 min |
| Magnetic | Average particle diameter | | 20.8/ | 19.9/ |
| Alloy | of grains (nm)/ | | 60/0 | 65/0 |
| | Crystal volume fraction (%)/ | | | |
| | Coarse particle ratio(%) | | | |
| | Bm (T) | | 1.52 | 1.51 |
| | Bs(T) | | 1.61 | 1.59 |
| | Hc (A/m) | | 39.70 | 27.72 |
| | Pcv(mW/cm³) | 50 kHz | 45.72 | 38.49 |
| | | 100 kHz | 134.10 | 123.10 |
| | Permeability | 100 KHz | 6664.10 | 6857.40 |

As can be confirmed from Table 1, while implementing a saturation magnetic flux density of 1.6 T or more, the Fe-based soft magnetic alloys according to Examples 1 and 2 had a coercive force of 50 A/m or less, and also a core loss of 50 mW/cm³ or less at 50 kHz and 200 mW/cm³ at 100 kHz, and accordingly, it can be seen that a soft magnetic alloy with low magnetic loss was implemented. In addition, since the permeability at 100 kHz was very high at 6,500 or more, it can be expected to be useful as a shielding member.

### Examples 3 to 9

These were prepared in the same manner as in Example 1, except that the Fe-based soft magnetic alloys shown in Table 2 were prepared by changing the composition and heat treatment conditions as shown in Table 2 below.

### Comparative Example 1

It was prepared in the same manner as in Example 1, except that the Fe-based soft magnetic alloy shown in Table 2 was prepared by changing the composition and heat treatment conditions as shown in Table 2 below.

### Experimental Example 2

The magnetic properties according to Experimental Example 1 were evaluated for the Fe-based soft magnetic alloys according to Examples 3 to 9 and Comparative Example 1, and the results are shown in Table 2 below.

TABLE 2

| | | | | | | | | Comparative | | |
|---|---|---|---|---|---|---|---|---|---|---|
| | | | Example 3 | Example 4 | Example 5 | Example 6 | Example 7 | Example 1 | Example 8 | Example 9 |
| Composition | X | Fe | 74.5 | 75.5 | 74.5 | 75.0 | 74.5 | 73.5 | 74.3 | 74.3 |
| (at %) | | Co | 5.0 | 4.0 | 4.0 | 4.0 | 4.3 | 0.0 | 3 | 3 |
| | | Ni | 0.0 | 0.0 | 0.0 | 0.0 | 0.0 | 0.0 | 2 | 2 |
| | B | | 12.0 | 12.0 | 12.0 | 12.0 | 13.0 | 9.0 | 13 | 13 |
| | Si | | 4.5 | 4.5 | 5.5 | 5.0 | 4.3 | 13.5 | 5 | 5 |
| | Cu | | 1.0 | 1.0 | 1.0 | 1.0 | 1.0 | 1.0 | 0.7 | 0.7 |
| | Nb | | 2.0 | 2.0 | 2.0 | 2.0 | 2.0 | 3.0 | 2 | 0 |
| | Mo | | 1.0 | 1.0 | 1.0 | 1.0 | 1.0 | 0.0 | 0 | 2 |
| | Total | | 100 | 100 | 100 | 100 | 100 | 100 | 100 | 100 |
| | X | | 79.5 | 79.5 | 78.5 | 79.0 | 78.8 | 73.5 | 79.3 | 79.3 |
| | B + Si | | 16.5 | 16.5 | 17.5 | 17.0 | 17.3 | 22.5 | 18.0 | 18.0 |
| | Mathematical Formula 1 | | 3.42 | 3.42 | 3.90 | 3.66 | 3.78 | 6.89 | 4.09 | 4.09 |
| Initial | Width (mm) | | 20 | 20 | 20 | 20 | 20 | 20 | 20 | 20 |
| Alloy | | | | | | | | | | |
| Fe- | Heat treatment | | 580/20 | 580/20 | 560/20 | 560/20 | 550/20 | 540/30 | 540/20 | 540/20 |
| based | temperature (° C.)/ | | | | | | | | | |
| Soft | Treatment time (min) | | | | | | | | | |
| Magnetic | Bm (T) | | 1.50 | 1.47 | 1.44 | 1.45 | 1.46 | 1.14 | 1.46 | 1.55 |
| Alloy | Bs(T) | | 1.66 | 1.63 | 1.61 | 1.61 | 1.61 | 1.23 | 1.58 | 1.61 |
| | Hc (A/m) | | 28.95 | 44.04 | 20.77 | 26.95 | 27.41 | 3.42 | 41.33 | 60.11 |
| | Pcv | 50 kHz | 49.21 | 68.75 | 38.79 | 42.30 | 47.32 | 18.93 | 155.98 | 124.18 |
| | (mW/cm³) | 100 kHz | 174.88 | 185.73 | 128.06 | 118.25 | 135.40 | 70.07 | 381.82 | 294.74 |
| | Permeability | 100 kHz | 6,457 | 6,568 | 6,822 | 6,780 | 6,435 | 20,594 | 5,984 | 5,723 |

As can be confirmed from Tables 1 and 2, in the case of Comparative Example 1, it can be seen that the content of B+Si exceeds 19 a %, and thus, the saturation magnetic flux density was implemented to be significantly reduced as the content of Fe was relatively reduced.

Additionally, in the case of Examples 8 and 9 containing more than 1 at % of Ni as the X element, it can be seen that the core loss was reduced compared to Examples 1 to 7.

### Examples 10 to 20

These were prepared in the same manner as in Example 1, except that the Fe-based soft magnetic alloys shown in Table 3 or Table 4 were prepared by changing the composition, width and heat treatment conditions as shown in Table 3 or Table 4 below.

### Comparative Examples 2 to 3

These were prepared in the same manner as in Example 1, except that the Fe-based soft magnetic alloys shown in Table 3 or Table 4 were prepared by changing the composition, width and heat treatment conditions as shown in Table 3 or Table 4 below.

### Experimental Example 3

The following physical properties were evaluated for the Fe-based soft magnetic alloys according to Examples 10 to 20 and Comparative Examples 2 to 3, and the results are shown in Table 3 below.

### 1. Reproducibility of Amorphous Initial Alloy

After preparing 100 initial alloy specimens for each example and comparative example, the analysis of crystal structure was performed on the prepared initial alloy specimens in the same manner as in Experimental Example 1, and the number of specimens having an amorphous structure among 50 specimens was expressed as a percentage.

### 2. Evaluation of Magnetic Properties

Magnetic properties were evaluated in the same manner as in Experimental Example 1 for the Fe-based soft magnetic alloy having a width of 20 mm prepared by heat treatment according to each example and comparative example.

TABLE 3

| | | | Comparative | Example | Example | Example | Example | Example | Example |
|---|---|---|---|---|---|---|---|---|---|
| | | | Example2 | 10 | 11 | 12 | 13 | 14 | 15 |
| Composition | X | Fe | 78.0 | 76.5 | 76.0 | 75.5 | 78.5 | 74.5 | 73.0 |
| (at %) | | Co | 5.0 | 4.5 | 4.5 | 4.5 | 1.0 | 5.0 | 6.5 |
| | B | | 11.0 | 12.0 | 10.5 | 12.0 | 12.0 | 12.0 | 12.0 |
| | Si | | 2.5 | 3.0 | 5.0 | 4.0 | 4.5 | 4.5 | 4.5 |
| | Cu | | 1.0 | 1.0 | 1.0 | 1.0 | 1.0 | 1.0 | 1.0 |
| | Nb | | 1.5 | 2.0 | 2.0 | 2.0 | 2.0 | 2.0 | 2.0 |
| | Mo | | 1.0 | 1.0 | 1.0 | 1.0 | 1.0 | 1.0 | 1.0 |
| | Total | | 100 | 100 | 100 | 100 | 100 | 100 | 100 |
| | X | | 83.0 | 81.0 | 80.5 | 80.0 | 79.5 | 79.5 | 79.5 |
| | B + Si | | 13.5 | 15.0 | 15.5 | 16.0 | 16.5 | 16.5 | 16.5 |
| | Mathematical Formula 1 | | 2.20 | 2.76 | 2.98 | 3.20 | 3.42 | 3.42 | 3.42 |
| Initial | Reproducibility | Width | 60 | 100 | 80 | 100 | 80 | 100 | 100 |
| Alloy | of amorphous | 20 mm | | | | | | | |
| | state by | Width | 30 | 90 | 40 | 100 | 50 | 100 | 100 |
| | width (%) | 30 mm | | | | | | | |
| Fe- | Heat treatment | | 600/20 | 590/20 | 590/20 | 590/20 | 620/20 | 580/20 | 580/20 |
| based | temperature (° C.)/ | | | | | | | | |
| Soft | Treatment time (min) | | | | | | | | |
| Magnetic | Bs(T) | | 1.83 | 1.77 | 1.73 | 1.67 | 1.72 | 1.66 | 1.54 |
| Alloy | Hc (A/m) | | 53.61 | 42.70 | 37.26 | 32.05 | 44.12 | 28.95 | 44.73 |
| | Pcv | 50 kHz | 184.61 | 136.19 | 106.19 | 53.86 | 56.12 | 49.21 | 63.43 |
| | (mW/cm³) | 100 kHz | 375.61 | 305.57 | 254.10 | 187.75 | 192.96 | 174.88 | 265.61 |
| | Permeability | 100 kHz | 4,000 | 4,900 | 5,250 | 5,780 | 3,500 | 6,457 | 7,340 |

TABLE 4

| | | | | | | | Comparative |
|---|---|---|---|---|---|---|---|
| | | | Example 16 | Example 17 | Example 19 | Example 20 | Example 3 |
| Composition | X | Fe | 76.5 | 75.0 | 73.5 | 74.5 | 71.0 |
| (at %) | | Co | 3.0 | 4.5 | 4.5 | 5.0 | 4.5 |
| | B | | 12.0 | 15.5 | 13.0 | 12.0 | 15.0 |
| | Si | | 4.5 | 1.0 | 5.0 | 4.5 | 5.0 |
| | Cu | | 1.0 | 1.0 | 1.0 | 1.0 | 1.0 |
| | Nb | | 2.0 | 2.0 | 2.0 | 1.0 | 2.5 |
| | Mo | | 1.0 | 1.0 | 1.0 | 2.0 | 1.0 |
| | Total | | 100 | 100 | 100 | 100 | 100 |
| | X | | 79.5 | 79.5 | 78.0 | 79.5 | 75.5 |
| | B + Si | | 16.5 | 16.5 | 18.0 | 16.5 | 20.0 |
| | Mathematical Formula 1 | | 3.42 | 3.42 | 4.15 | 3.42 | 5.30 |
| Initial | Reproducibility | 20 mm width | 100 | 100 | 100 | 100 | 100 |
| Alloy | of amorphous | 30 mm width | 90 | 100 | 100 | 100 | 100 |
| | state by | | | | | | |
| | width (%) | | | | | | |
| Fe- | Heat treatment | | 600/20 | 580/20 | 580/20 | 580/20 | 520/20 |
| based | temperature (° C.)/ | | | | | | |
| Soft | Treatment time (min) | | | | | | |
| Magnetic | Bs(T) | | 1.74 | 1.67 | 1.60 | 1.66 | 1.34 |
| Alloy | Hc (A/m) | | 25.84 | 34.74 | 23.83 | 49.90 | 11.19 |
| | Pcv | 50 kHz | 43.50 | 99.05 | 42.34 | 83.91 | 29.6 |
| | (mW/cm³) | 100 kHz | 162.78 | 347.37 | 157.29 | 322.47 | 115.4 |
| | Permeability | 100 kHz | 5,111 | 5,830 | 7,120 | 4,300 | 11,800 |

As can be confirmed from Tables 3 and 4, it can be seen that the reproducibility of Comparative Example 2 in which the sum of the B and Si contents in the Fe-based soft magnetic alloy was too low, was greatly reduced compared to Example 10, and particularly, when the ribbon width increased to 30 mm, it was further reduced. Additionally, in the case of Comparative Example 3 in which the sum of B and Si contents was excessive, it can be seen that the reproducibility of the amorphous initial alloy was good, but the saturation magnetic flux density was significantly reduced compared to those of the examples.

Meanwhile, in the case of Example 11, the sum of the contents of B and Si was at an appropriate level and satisfied the preferred range of Mathematical Formula 1 according to the present invention, but when the ribbon width increased to 30 mm as the B content was contained at less than 11 at %, it can be seen that the implementation reproducibility of the amorphous initial alloy was deteriorated.

Although one exemplary embodiment of the present invention has been described above, the spirit of the present invention is not limited to the exemplary embodiments presented in the present specification, and those skilled in the art who understand the spirit of the present invention may easily suggest other exemplary embodiments by changing, modifying, deleting or adding components within the scope of the same spirit, but this will also fall within the scope of the present invention.

What is claimed is:

1. An Fe-based soft magnetic alloy, wherein the Fe-based soft magnetic alloy is represented by an empirical formula XₐB_{b}Si_{c}Cu_{d}Mₑ,
wherein in the empirical formula, X includes Fe and at least one element among Ni and Co; M includes at least one element among Nb and Mo; a, b, c, d and e indicate an atomic percent (at %) of corresponding elements, wherein 15.0≤b+c≤19.0, 0.5≤d≤1.5, and 2.0≤e≤5.0; and X is included as a remainder.

2. The Fe-based soft magnetic alloy of claim 1, wherein a is included at 75.0 to 81.5 at %, Co is included at 2.0 to 5.0 at %, and Ni is included at 0 to 1 at % in the empirical formula.

3. The Fe-based soft magnetic alloy of claim 1, wherein b is 11.0 to 16.0 at %, and c is 2.0 to 6.5 at % in the empirical formula.

4. The Fe-based soft magnetic alloy of claim 1, wherein in the empirical formula, b is 11.0 to 16.0 at %, and a value according to Mathematical Formula 1 below for a, b and c is 2.75 to 4.50:
$$\frac{{( b + c )}^{2}}{a} .$$

5. The Fe-based soft magnetic alloy of claim 4, wherein the value of Mathematical Formula 1 above is 3.20 to 4.50.

6. The Fe-based soft magnetic alloy of claim 4, wherein c is 2.0 to 5.0 at % in the empirical formula.

7. The Fe-based soft magnetic alloy of claim 4, wherein M includes Nb and Mo in the empirical formula.

8. The Fe-based soft magnetic alloy of claim 7, wherein Nb is contained in a greater content than Mo.

9. The Fe-based soft magnetic alloy of claim 1, wherein e is 2.5 to 4.0 at % in the empirical formula.

10. The Fe-based soft magnetic alloy of claim 1, wherein the Fe-based soft magnetic alloy comprises crystal grains, wherein the crystal grains have an amorphous structure or an average particle diameter of 30 nm or less in an amorphous matrix.

11. A method for preparing an Fe-based soft magnetic alloy, comprising:
preparing a soft magnetic alloy, wherein the soft magnetic alloy is represented by an empirical formula XₐB_{b}Si_{c}Cu_{d}Mₑ, wherein in the empirical formula, X includes Fe and at least one element among Ni and Co; M includes at least one element among Nb and Mo; a, b, c, d and e indicate an atomic percent (at %) of corresponding elements, wherein 15.0≤b+c≤19.0, 0.5≤d≤1.5, and 2.0≤e≤5.0; and X is included as a remainder.

12. The method of claim 11, further comprising:
heat treating the soft magnetic alloy at a temperature of 530 to 620° C. for 10 to 60 minutes.

13. A shielding member, comprising the Fe-based soft magnetic alloy according to claim 1.

14. The Fe-based soft magnetic alloy of claim 5, wherein c is 2.0 to 5.0 at % in the empirical formula.
